(19) United States
(12) Patent Application Publication
(10) Pub. No.: US 2015/0067150 A1
(43) Pub. Date: Mar. 5, 2015

(54) SYSTEMS AND METHODS FOR PROACTIVE MEDIA DATA SHARING

(71) Applicant: Samsung Electronics Co., Ltd., Suwon-si (KR)

(72) Inventors: Edwin A. Heredia, San Jose, CA (US); Shailendra Kumar, Fremont, CA (US); Jun Nishimura, Sunnyvale, CA (US); George Hsieh, Sunnyvale, CA (US); Alan Messer, Los Gatos, CA (US)

(21) Appl. No.: 14/340,014

(22) Filed: Jul. 24, 2014

Related U.S. Application Data
(60) Provisional application No. 61/872,355, filed on Aug. 30, 2013.

(51) Int. Cl. H04L 29/06; G06F 3/0484; G06F 17/30; H04L 12/26

(52) U.S. Cl. CPC H04L 65/403; H04L 43/08; G06F 3/0484; G06F 17/30342
USPC 709/224; 715/716

(57) ABSTRACT

In some embodiments, a computer implemented method, a system, and/or a non-transitory computer readable medium can receive an actionable rule that represents user intent to share media data. The actionable rule can be analyzed to determine a set of conditions and a set of actions included in the actionable rule. The actionable rule, including the set of conditions and the set of actions, can be stored in a rule database. Context data can be acquired from a context database. Whether or not the set of conditions is satisfied based on the acquired context data can be determined. The set of actions can be executed when the set of conditions is satisfied based on the acquired context data. In some cases, executing the set of actions can include, at least in part, initiating a sharing of the media data with at least one target system.

This application claims priority to U.S. Provisional Application No. 61/872,355, filed on Aug. 30, 2013 and titled “A Contextually Proactive System For Media Sharing Scenarios” which is incorporated by reference herein in its entirety.

### FIELD OF THE INVENTION

The present technology relates to the field of data sharing. More particularly, the present technology discloses proactive media data sharing.

### BACKGROUND

Conventional approaches to transferring or sharing data, such as media data, from one device to another can require manually configuring multiple devices such that the devices can communicate and operate with one another. Conventional approaches can also require a user of the devices to manually select the media data to be transferred. Moreover, the transfer of media data from one device to another typically does not occur until after the user has manually initiated the transfer. In one example, to utilize video streaming in accordance with conventional approaches, a user of a mobile computing device has to manually set up a connection between the mobile computing device and another device, such as a television streaming device (e.g., set top box). The user may also need to manually select a video file to be streamed from the mobile computing device to the television streaming device. Further, in conventional approaches, video data typically does not begin transferring until the user initiates a command for the video to be streamed.

Conventional approaches to transferring or sharing media data can be limited. For example, there can be many devices (and/or systems) available today, which can result in many different configurations required for transferring or sharing media data among the devices. It can be inconvenient or difficult for users to learn how to manually configure each of the devices for media data sharing. It can also be inconvenient or difficult for the users to perform the various manual configurations. Furthermore, under conventional approaches, the users usually have to wait for shared media data to be accessible (e.g., loaded, buffered) because the media data does not begin transferring or being shared until the users have initiated the appropriate command(s). These and other concerns can reduce the overall user experience associated with media data sharing.

### SUMMARY

To utilize proactive media data sharing, computer implemented methods, systems, and non-transitory computer readable media, in an embodiment, can receive an actionable rule that represents user intent to share media data. The actionable rule can be analyzed to determine a set of conditions and a set of actions included in the actionable rule. The actionable rule, including the set of conditions and the set of actions, can be stored in a rule database. Context data can be acquired from a context database. Whether or not the set of conditions is satisfied based on the acquired context data can be determined. The set of actions can be executed when the set of conditions is satisfied based on the acquired context data. In some cases, executing the set of actions can include, at least in part, initiating a sharing of the media data with at least one target system.

In one embodiment, new context data can be received. The new context data can be stored in the context database. Information associated with a plurality of actionable rules stored in the rule database can be acquired. In some instances, the information can indicate sets of conditions and sets of actions included in the plurality of actionable rules. It can be determined that a respective set of conditions included in at least one of the plurality of actionable rules is satisfied based on the new context data. A respective set of actions included in the at least one of the plurality of actionable rules can be executed.

In one embodiment, the set of conditions can specify at least one of a time at which the media data is to be shared, an identifier for each of the at least one target system with which the media data is to be shared, an identifier for an entity with whom the media data is to be shared, a target location for the entity, an identifier for the media data, a location at which the media data is stored, or a state of the media data.

In one embodiment, the set of conditions included in the actionable rule can be analyzed. One or more technical requirements can be derived based on analyzing the set of conditions. In some cases, determining whether the set of conditions is satisfied can include determining whether the one or more technical requirements are satisfied.

In one embodiment, the sharing of the media data can be initiated subsequent to the at least one target system becoming network-reachable.

In one embodiment, there can be a communication with the at least one target system causing the media data to be provided via the at least one target system.

In one embodiment, the media data can be provided via the at least one target system subsequent to at least a portion of the media data being shared with the at least one target system.

In one embodiment, the media data can be provided via the at least one target system based on a state of the media data. The state of the media data can indicate a paused playback position associated with the media data.

In one embodiment, a message can be communicated prior to the media data being provided via the at least one target system. The message can indicate that the media data is ready to be provided via the at least one target system.

In one embodiment, the media data can be provided via the at least one target system subsequent to receiving a command in response to the message.

In one embodiment, the actionable rule can be represented in Rich Interchange Format (RIF). It is also contemplated that the actionable rule can be represented in many other formats.

In one embodiment, the context database can correspond to a deductive database. In some instances, at least a portion of the context data can be acquired based on inference with respect to at least two other portions of context information stored in the deductive database.

In one embodiment, at least a portion of the acquired context data can be provided by a system, a computer-implemented method, and/or a non-transitory computer-readable medium.

In one embodiment, the media data can be associated with at least one of an image, a video, an audio, a literary piece, or an application.

Many other features and embodiments of the invention will be apparent from the accompanying drawings and from the following detailed description.

### BRIEF DESCRIPTION OF THE DRAWINGS

FIG. 1 illustrates an example environment in which proactive media data sharing can be utilized, according to an embodiment of the present disclosure.

FIG. 2A illustrates an example flowchart for providing proactive media data sharing, according to an embodiment of the present disclosure.

FIG. 2B illustrates an example flowchart for providing proactive media data sharing, according to an embodiment of the present disclosure.

FIG. 3A illustrates an example scenario in which proactive media data sharing can be utilized, according to an embodiment of the present disclosure.

FIG. 3B illustrates the example scenario of FIG. 3A in which proactive media data sharing can be utilized, according to an embodiment of the present disclosure.

FIG. 3C illustrates the example scenario of FIG. 3B in which proactive media data sharing can be utilized, according to an embodiment of the present disclosure.

FIG. 3D illustrates an example system in which proactive media data sharing can be utilized, according to an embodiment of the present disclosure.

FIG. 4 illustrates an example method embodiment for utilizing proactive media data sharing, according to an embodiment of the present disclosure.

FIG. 5 illustrates an example of a computing device or system that can be used to implement one or more of the embodiments described herein, according to an embodiment of the present disclosure.

FIG. 6 illustrates a network environment in which various embodiments can be implemented.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

### Proactive Media Data Sharing

Often times, people use computing devices and/or systems to share data, such as media data. For example, a first user of a first computing device can transmit (i.e., share) an image to a second user of a second computing device. In another example, the first user can play music on the first computing device and allow the second user to listen to the music via the first computing device. In a further example, the first user can be viewing a video on the first computing device, such as a smartphone, but can stream the video to another computing device, such as a smart television (TV).

However, due to the wide variety of computing devices (and/or systems) and technologies, there can often be issues or challenges associated with implementing and/or using media data sharing. In one example, a first computing device might not be operable or compatible with a second computing device to share media data. In another example, a user of the first and second computing devices might not know how to set up and/or configure the first and second devices for media data sharing. In another example, the user might know how to set up and configure media data sharing, but the process might take too much time and effort. In a further example, the context in which media data sharing occurs can change (e.g., a computing device can be disconnected from a network, a new computing device might join the network, etc.). In yet another example, the user's intent to share media data can change, thereby adding more complications to media data sharing.

Accordingly, it can be desirable to provide media data sharing in an automatic manner, such that users do not have to manually configure various devices (and/or systems). It can be desirable to share media data in a proactive manner, such that users do not have to frequently instruct the devices to performs tasks related to media data sharing. Furthermore, it can be desirable to provide media data sharing in a manner that is dependent upon user intent and/or the context(s) in which the media data is to be shared.

The present disclosure describes a media sharing module configured to provide proactive media data sharing. In some embodiments, the user's intent to share media data can be specified or inputted by the user. The user's intent can be generated as at least one actionable rule, which can include at least one set of conditions and at least one set of actions. The set of conditions can correspond to requirements or prerequisites for sharing media data in accordance with the user's intent. The set of actions can correspond to media sharing tasks in accordance with the user's intent. The set of actions in an actionable rule can be performed when the corresponding set of conditions in the actionable rule is satisfied.

In some embodiments, the actionable rule can be received and analyzed (e.g., parsed) by the media sharing module. The set of conditions for the actionable rule can be compared with context data acquired by the media sharing module from a context database. The context data can, for example, be provided or acquire from various context providers. The context data can provide information or details about the environment, the network(s), the user(s), the computing device(s), the media data, and/or various other components involved in the proactive media data sharing.

The media sharing module can then determine whether or not the set of conditions is satisfied based on the context data. If so, then the corresponding set of actions for the actionable rule can be performed and the media data can be shared in accordance with the user's intent. If, however, the context data does not satisfy the set of conditions, then the media sharing module can wait for new context data and/or a new actionable rule(s).

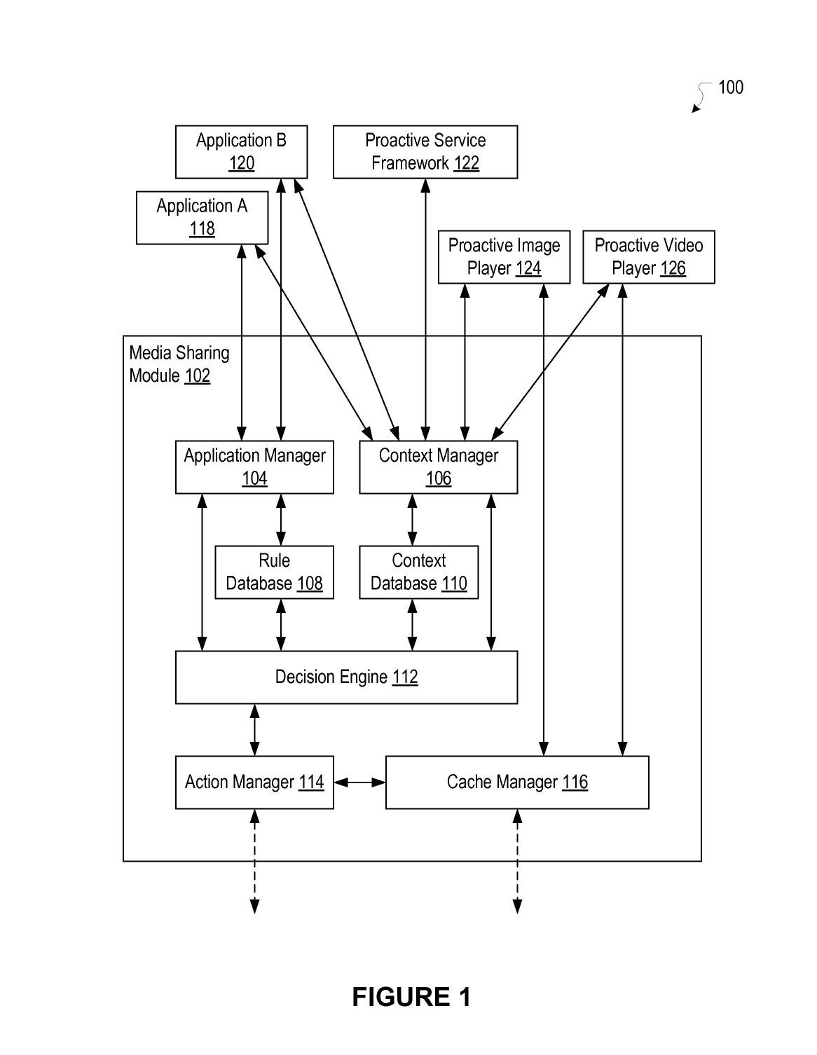

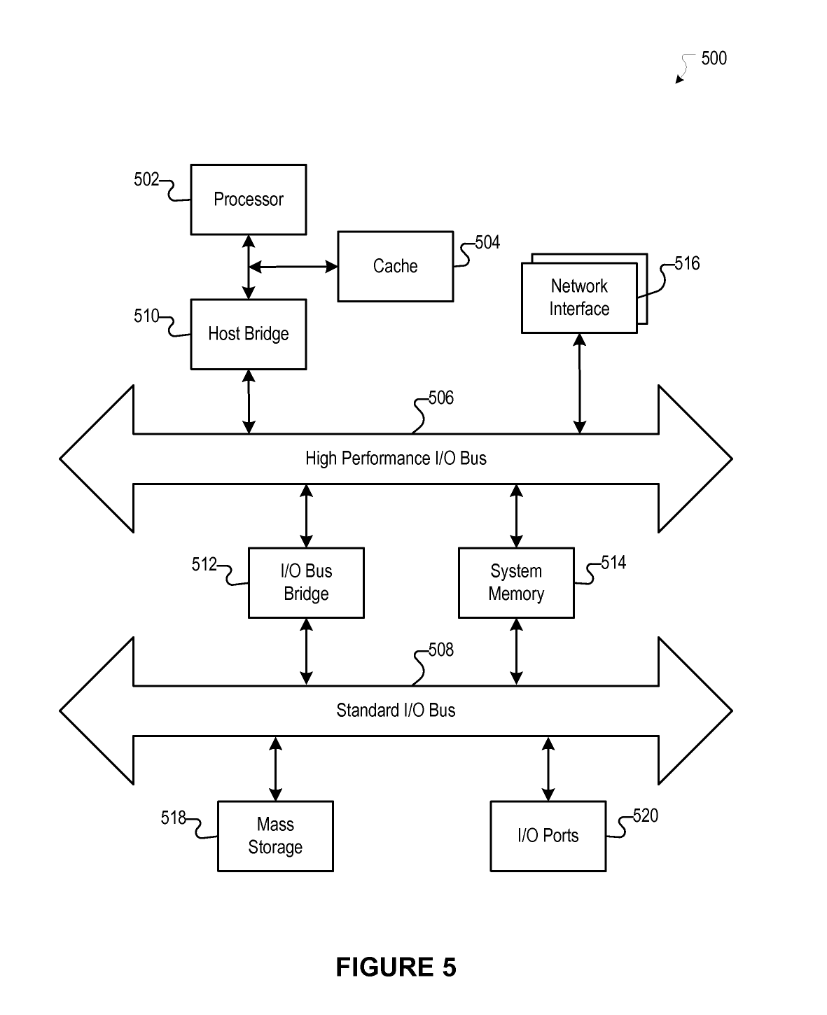

FIG. 1 illustrates an example environment 100 in which proactive media data sharing can be utilized, according to an embodiment of the present disclosure. The example environment 100 can include a media sharing module 102 configured to facilitate the performance of various tasks related to proactive media data sharing. In some embodiments, the media sharing module 102 can be implemented as software, hardware, and/or any combination thereof. In one example, the media sharing module 102 can be implemented within an operating system (OS) of a computing device and/or system (e.g., 500 in FIG. 5). In another example, the media sharing module 102 can be implemented within an application or program installed or running on a computing device (and/or system). Moreover, in some cases, the media sharing module 102 (or an instance thereof) can be implemented in each computing device involved in proactive media data sharing. Various other implementations for the media sharing module 102 are also possible.

In the example of FIG. 1, the media sharing module 102 can comprise an application manager 104, a context manager 106, a rule database 108, a context database 110, a decision engine 112, an action manager 114, and a cache manager 116. Moreover, the example environment 100 can include one or more applications (e.g., Application A 118, Application B 120, etc.), a proactive service framework 122, and one or more proactive media players (e.g., Proactive Image Player 124, Proactive Video Player 126, etc.). It is contemplated that the example environment 100 is provided for illustrative purposes and that many other variations and/or modifications can be implemented.

In some embodiments, the application manager 104 can be configured to receive and process actionable rules. An actionable rule can refer to information that represents a user's intent to carry out one or more particular tasks, such as one or more tasks related to media data sharing. In some embodiments, the actionable rule can include a set of conditions (e.g., contextual conditions) and a set of actions. The actionable rule can require the set of conditions to be satisfied before the set of actions can be performed. The set of conditions can be used to derive information describing criteria that need to be met for the set of actions to take place. For example, the set of conditions can specify if, when, how, in what manner, etc., the set of actions is to be performed. The set of actions can correspond to various activities or processes associated with sharing media data.

In some cases, a user can input an actionable rule via an application (e.g., 118, 120, etc.). The actionable rule can indicate what the user's intentions are. In one example, the user can input or specify, in an actionable rule, that if the user pauses a video being played on the user's smartphone outside the user's home, then the video can resume playing on the television at home at the paused position when the user (returns home and) is near the television at home. In this example, the set of conditions can include (but is not limited to) to the following: 1) a video must have been playing on the user's smartphone while the smartphone was outside the user's home; 2) the video must have been paused during the playback; 3) the television is currently network-reachable by the smartphone and vice versa (i.e., the television and smartphone can communicate with one another via a network); and so forth. The set of actions can include: 1) initiating a sharing or a transferring of (at least a portion of) the video from the smartphone to the television at home; and 2) indicating the paused playback position for the video. In some cases, there can be an additional condition requiring the user to be currently near the television at home. It follows that there can be an additional action instructing the smartphone to ask the user whether the user would like to resume the video on the television at home. If (and when) the user replies affirmatively (which can be a further condition), then the video can resume on the television at home from the paused playback position (which can be a further action).

As discussed above, the set of conditions can be used to derive information describing criteria that need to be met in order for the set of actions to take place. The application manager 104 can analyze the set of conditions to derive one or more technical requirements. Continuing with the previous example, technical requirements derived from the previous set of conditions can include (but are not limited to): 1) the smartphone with serial number 123456789 being associated with the user (e.g., the user owns the smartphone, the user is the primary account holder for the smartphone, etc.); 2) the video being played on the smartphone; 3) the smartphone was not connected to the user's home network (e.g., WiFi, WLAN, LAN, Bluetooth®, etc.) while the video was being played; 4) the video was paused at a playback position between the start and end times of the video; 5) the smartphone is now connected to the user's home network; 6) the television at home is identified by Internet Protocol (IP) address 12.345.678 and/or by media access control (MAC) address A1-B2-C3-D4-E5-F6; 7) the television identified by IP address 12.345.678 and/or by MAC address A1-B2-C3-D4-E5-F6 is also connected to the user's home network; 8) the smartphone and the television can communicate and interact with one another via the user's home network; and so forth. If (and when) the technical requirements are all satisfied, the set of actions can be performed. For example, (if and) when the smartphone and television can communicate via the user's home network and the other requirements are met, then the smartphone can begin transmitting video data to the television to be cached at the television.

Moreover, in the previous example, the additional condition requiring the user to be currently near the television can be described in more technical detail as well. For example, technical requirements derived from the additional condition can include (but are not limited to): 1) the user's location (e.g., inferred or deduced from the user's smartphone location) being within a specified distance (e.g., 5 feet, 10 feet, etc.) from the location of the television (IP address 12.345.678 and/or MAC address Al -B2-C3-D4-E5-F6) based on WiFi signal location triangulation and/or Global Positioning System (GPS) signals; 2) the user's smartphone being connected to the television via a Bluetooth® signal with a signal strength exceeding a specified threshold; 3) the user's smartphone being able to communicate with the television via infrared (IR) signals (e.g., a direct line of sight); 4) the user is viewable from a front-facing camera and/or proximity sensor associated with the television; and so forth. In this case, not all of the technical requirements need to be satisfied for the additional condition to be satisfied. Thus, (if and) when at least some of these technical requirements are satisfied, the smartphone can message the user telling the user that the video is ready to be played at the television. The user can reply to the message to instruct the video to begin playing on the television.

In another example, the user intends to invite over his or her family this coming Saturday evening to see pictures from the user's vacation in Hawaii. As such, the user can create (or use the one or more applications to create) an actionable rule that specifies that the pictures taken by the user on the user's smartphone during the user's vacation in Hawaii are to be displayed on the living room television to the user and the user's family members this coming Saturday at or after 5 PM. In this example, the set of conditions can include: 1) the presence of pictures taken by the user stored on the user's smartphone; 2) the pictures are tagged as being associated with Hawaii; 3) the living room television is network-reachable by the smartphone (and vice versa); 4) the user and one or more persons must be near the living room television; 5) the one or more persons must be family members of the user; 6) the time (and day) for playback is this Saturday at or after 5 PM; and so forth. In this example, the set of actions can include initiating a sharing or a transferring of the pictures from the smartphone to the living room television when the television is network-reachable by the smartphone. (The sharing or transferring of the pictures can begin before Saturday 5 PM such that the pictures can already be shared with and cached by the television at or before 5 PM.) Then there can be an additional action instructing the smartphone to ask the user whether the user would like to display the pictures on the television when the user and one or more family members are near the television and when the time is at or after 5 PM. When the user replies affirmatively, then the pictures can be displayed on the television.

It is contemplated that the previous examples are provided for illustrative purposes and that various other examples and scenarios are also possible.

In some embodiments, the application manager 104 can be configured to communicate with one or more computing devices (and/or systems), which can be running one or more applications (e.g., 118, 120, etc.). In some embodiments, the one or more applications can be running on the same device (and/or system) associated with the media sharing module 102. The one or more applications can provide actionable rules, which can be received by the application manager 104. In one example, when an actionable rule is received, the application manager 104 can process the received actionable rule. The application manager 104 can the analyze (e.g., parse) the received actionable rule to determine or identify at least one set of conditions and at least one set of actions included in the received actionable rule. The application manager 104 can communicate with and/or operate in conjunction with the rule database 108 to store the received actionable rule, including the (at least one) set of conditions and the (at least one) set of actions, in the rule database 108.

The application manager 104 can also interact and communicate with the decision engine 112. The decision engine 112 can be configured to determine whether or not the set of conditions included in the received actionable rule is satisfied. To determine whether the set of conditions is satisfied, the decision engine 112 can communicate with the context database 110, which can be configured to store context data. The decision engine 112 can acquire the context data stored at the context database 110. Context data can include one or more environmental variables measured by a computing device (and/or system). The context data acquired from the context database 110 can provide details about the current context and/or the current state of relevant computing devices (and/or systems). The decision engine 112 can then determine whether or not the acquired context data satisfies the set of conditions (e.g., technical requirements) included in the received actionable rule. If so, the decision engine 112 can work with the action manager 114 to carry out the set of actions included in the received actionable rule. The action manager 114 can be configured to process and/or execute the set of actions appropriately, which can include causing the set of actions to be performed locally (at the computing device with the media sharing module 102) and/or remotely (at one or more other computing devices).

In some cases, the set of actions to be performed can involve the action manager 114 working in conjunction with the cache manager 116 to transfer or share media data with a target system (i.e., another computing device with which the media data is intended to be shared). The cache manager 116 can be configured to manage one or more local caches and/or remote caches, at which media data can be stored. However, if the set of conditions is not satisfied by the acquired context data, then the set of actions included in the received actionable rule will not be performed and the media sharing module 102 can wait for new context data and/or a new actionable rule(s).

If a new actionable rule is received by the application manager 104, then the process(es) described above can repeat. If new context data is available, the new context data can be acquired (e.g., received, obtained, etc.) by the context manager 106. The context manager 106 can store the new context data in the context database 110. As such, the context database 110 can change over time to reflect changes in the current context. The context manager 106 can also interact with the decision engine 112 to determine whether or not the new context data satisfies any of the actionable rules, already stored in the rule database 108, whose conditions have yet to be satisfied. For example, if an actionable rule in the rule database 108 has all of its conditions (within a set) satisfied except for one, and the new context data satisfies the last remaining unsatisfied condition, then all of the actionable rule's conditions (within that set) are satisfied and the corresponding set of actions for the actionable rule can be performed. If, however, the new context data does not help to satisfy the unsatisfied conditions of any actionable rules in the rule database 108, then no sets of actions are performed and the media sharing module 102 can wait for new context data and/or new actionable rules.

In some cases, applications (e.g., 118, 120, etc.), the proactive service framework 122, proactive media players (e.g., 124, 126, etc.), and/or various other components can provide context data to the context manager 106. The context manager 106 can be configured to communicate and interact with such components, in order to acquire (e.g., receive, obtain, collect, aggregate, etc.) context data. As discussed above, context data can be used to describe details about the current context and/or the current state of relevant computing devices. In one example, an application(s) (e.g., 118, 120, etc.) and the media sharing module 102 can be running on the same computing device. In another example, the application(s) and the media sharing module 102 can be running on separate computing devices. In either example, the application(s) (or the computing device running the application(s)) can be configured to collect context data to provide to the context manager 106. The context data can include, for example, (absolute or relative) location information about the computing device, media data that is stored or accessed at the computing device, one or more users associated with the computing device, state information about the media data, one or more networks to which the computing device is connected, one or more other devices that are network-reachable, one or more other devices that are nearby, etc.

In another example, the proactive service framework 122 can be configured to collect context data from one or more devices and distribute the collected context data among the one or more devices via a network (e.g., the user's home network). The proactive service framework 122 can collect the context data, distribute the context data among various devices, and provide the context data to the context manager 106. The context data can indicate, for example, the availability of media data, the availability of information associated with the media data (e.g., metadata, tags, descriptions, authors, etc.), the status or state (e.g., paused, playing, slow playback, etc.) of local media data, the status or state of remote (e.g., web accessible) media data, the availability of messages (e.g., text messages, electronic mail, etc.), the readings or measurements of sensors, network connectivity data for various devices, and/or the locations of various devices, etc.

In a further example, in addition to rendering and playing media, the proactive media players (e.g., 124, 126) can be configured to obtain context data and provide the context data to the context manager 106. The proactive media players can also be configured to interact with the media sharing module 102 and to play cached (e.g., pre-cached) data. For example, Proactive Image Player 124 can be a software component that is configured to render images in a computing device, obtain context data related to the images, interact with the media sharing module 102, and play (e.g., display) cached image data. Similarly, Proactive Video Player 126 can, for example, be a software component configured to render videos in a computing device, obtain context data related to the videos, interact with the media sharing module 102, and play cached video data. As discussed above, it is contemplated that many variations and modifications are possible. For example, in some implementations, there can be a proactive audio player. In another example, the proactive media players can be optional in some cases.

In some embodiments, actionable rules can be represented in Rich Interchange Format (RIF). As such, when the application manager 104 receives an actionable rule, the actionable ruled can be included as a part of an RIF document received by the application manager 104. In some cases, an RIF document can include a plurality of actionable rules, each with its own respective (at least one) set of conditions and (at least one) set of actions. In some instances, each RIF document can be associated with a unique identifier. In some cases, each RIF document can be stored (or removed) from the rule database 108.

In some implementations, the context database 110 can correspond to a deductive database. As such, at least a portion of the context data can be acquired based on inference with respect to at least two other portions of context information stored in the deductive database. The context manager 106 and/or the deductive context database 110 can deduce or infer portions of context data based on other portions of context data. For example, if a first portion of context data specifies that a first device is next to a second device (e.g., determined based on GPS, WiFi signal strength, Bluetooth connectivity, etc.), and if a second portion of context data specifies that a third device is next to the second device, then the context manager 106 and/or the deductive context database 110 can infer or deduce a third portion of context data specifying that the third device is near the first device. Moreover, a fourth portion of context data can be inferred, which indicates that the first device is near the second device. In addition, a fifth portion of context data can be inferred, which specifies that the second device is near the third device. There can be various other inferred or deduced context data.

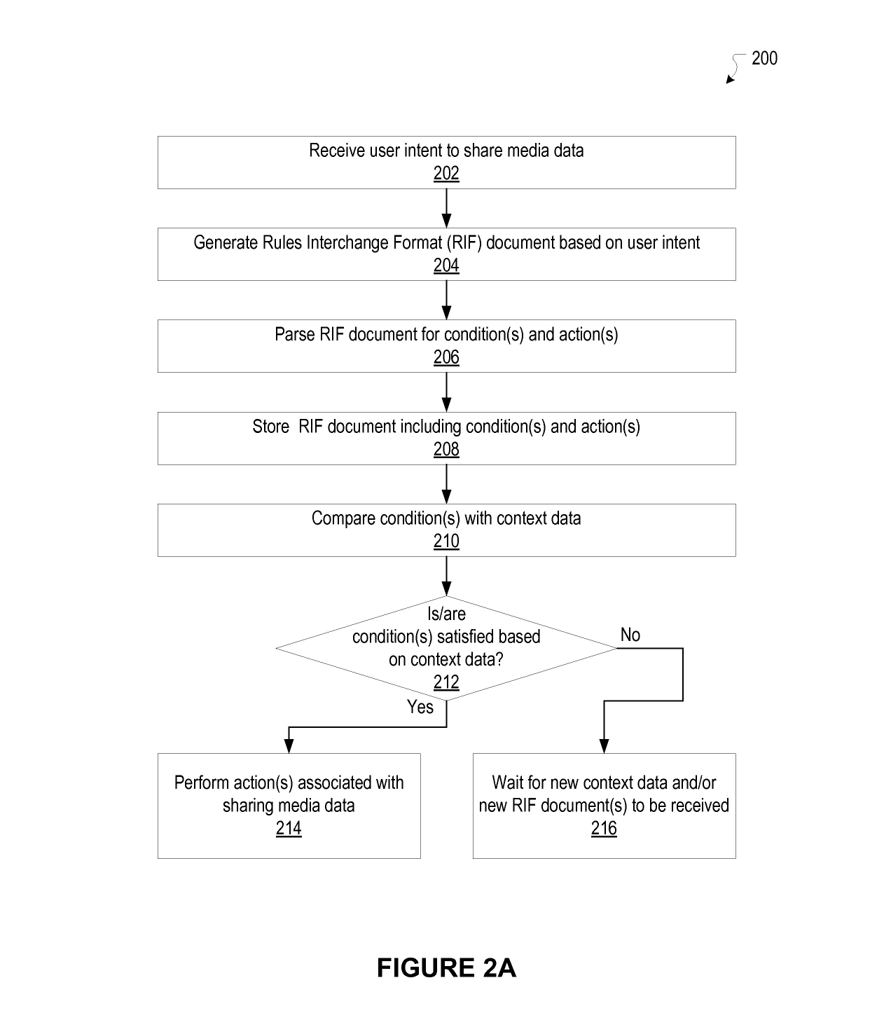

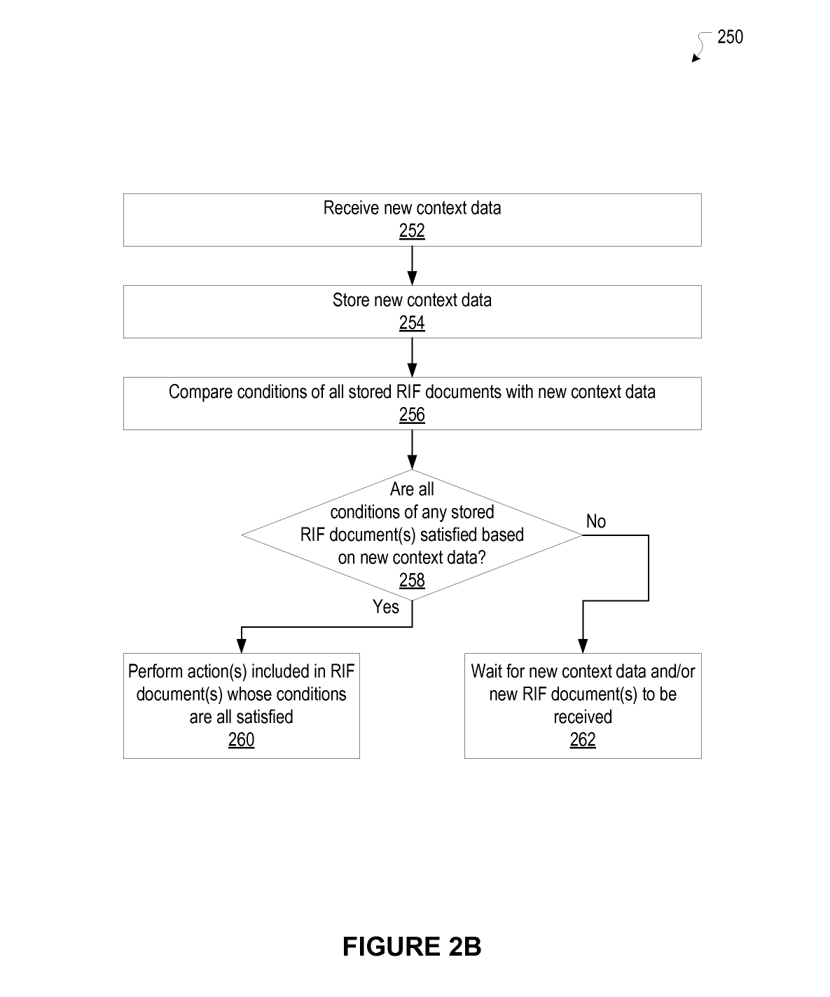

With reference to FIG. 2A, an example flowchart 200 for providing proactive media data sharing, according to an embodiment of the present disclosure, is illustrated. At block 202, user intent to share media data can be received. In one example, the user intent to share media data can be received by one or more applications (e.g., 118 and/or 120 in FIG. 1). The application(s) can analyze or otherwise process the received user intent to generate at least one actionable rule from the user intent. To generate the at least one actionable rule, the application(s) can utilize natural language parsing, speech-to-text, and/or various other techniques to decipher the user intent to share media data. Moreover, the actionable rule can be generated, based on the user intent, to include a set of (one or more) conditions and a set of (one or more) actions associated with sharing the media data.

At block 204, a Rules Interchange Format (RIF) document can be generated. For example, the RIF document can be generated by the one or more applications. The RIF document can be generated to incorporate the (at least one) actionable rule. Further, the RIF document incorporating the actionable rule can be transmitted by the application(s) to be received at a media sharing module (e.g., 102 in FIG. 1) or by an application manager (e.g., 104 in FIG. 1) included in the media sharing module.

The RIF document can be parsed or otherwise analyzed to determine the set of conditions and the set of actions, at block 206. For example, the RIF document can be parsed to determine the (at least one) actionable rule included therein. The actionable rule can then be parsed to determine the set of conditions and the set of actions. In some embodiments, the parsing or analyzing of the RIF document can be performed by the media sharing module (or by the application manager included therein).

At block 208, the RIF document incorporating the actionable rule, which includes the set of conditions and the set of actions, can be stored. For example, the application manager can work in conjunction with a rule database (e.g., 108 in FIG. 1) to store the RIF document in the rule database. Furthermore, the set of conditions can be compared with context data, at block 210. In some embodiments, when the actionable rule is received at the application manager, the application manager can (substantially) immediately, or within an allowable time period, interact with a decision engine (e.g., 112 in FIG. 1) to compare the set of conditions with context data acquired from a context database (e.g., 110 in FIG. 1).

The decision engine can determine whether or not the set of conditions for the actionable rule is satisfied based on comparison to the context data, at block 212. If the set of conditions is satisfied (e.g., all technical requirements and criteria specified in the actionable rule are met), then the set of actions included in the actionable rule can be performed, at block 214. For example, the decision engine can interact with an action manager (e.g., 114 in FIG. 1) to perform the set of actions, which can include various tasks required for sharing the media data as intended by the user. The action manager can cause the set of actions to be carried out appropriately, such as being performed locally and/or remotely as necessary. The action manager can also interact with a cache manager (e.g., 116 in FIG. 1) to acquire, retrieve, share, and/or transmit the media data as needed.

If, however, the set of conditions is not satisfied, then the set of actions is not performed and the media sharing module can wait, at block 216, for a new actionable rule(s), which can be included in a new RIF document(s), and/or new context data. When a new actionable rule is received, the above process can repeat. With regard to receiving new context data, discussions are provided below with reference to FIG. 2B.

FIG. 2B illustrates an example flowchart 250 for providing proactive media data sharing, according to an embodiment of the present disclosure. In particular, FIG. 2B illustrates an example flow for processing new context data. At block 252, new context data can be received (or acquired). For example, new context data can be provided by one or more applications (e.g., 118 and/or 120 in FIG. 1), by a proactive service framework (e.g., 122 in FIG. 1), by one or more proactive media players (e.g., 124 and/or 126 in FIG. 1), and/or various other components. The new context data can then be received (or acquired) by a context manager (e.g., 106 in FIG. 1), which can be included in a media sharing module (e.g., 102 in FIG. 1).

At block 254, the new context data can be stored. In some embodiments, the new context data can be stored in a context database (e.g., 110 in FIG. 1). In some cases, the new context data can provide additional context information or details. In some cases, the new context data can indicate that one or more portions of already present context data is obsolete, no longer accurate, etc. As such, due to the new context data, the context database can change over time. In some embodiments, the storing of the new context data at block 254 can occur before block 256, at which the conditions of all stored actionable rules are compared with the new context data. In some implementations, block 254 can take place sometime after block 256. In some embodiments, the storing of the new context data (at block 254) and the comparison of the conditions with the new context data (at block 256) can occur substantially simultaneously or within an allowable time period.

At block 256, conditions of all stored actionable rules (included in stored RIF documents) can be compared with the new context data. For example, the new context data can be compared with each respective set of conditions included in each actionable rule stored in a rule database (e.g., 108 in FIG. 1).

If the new context data results in the set of conditions being satisfied for a stored actionable rule (which can be included in a stored RIF document), then the set of actions for the stored actionable rule can be performed, at block 260. In other words, if one or more conditions included in a stored actionable rule had not been satisfied by the already present context data, but the new context data satisfies the one or more remaining unsatisfied conditions, then the action(s) included in the stored actionable rule can be carried out.

If, however, the new context data does not result in all conditions (e.g., in a set) being satisfied for any stored actionable rule, then no actions (e.g., in a corresponding set) are to be performed and the media sharing module can wait for a new actionable rule(s), which can be included in a new RIF document(s), and/or wait for new context data. If new context data is received, then the above process can repeat. With regard to receiving a new actionable rule(s), discussions are provided previously with reference to FIG. 2A.

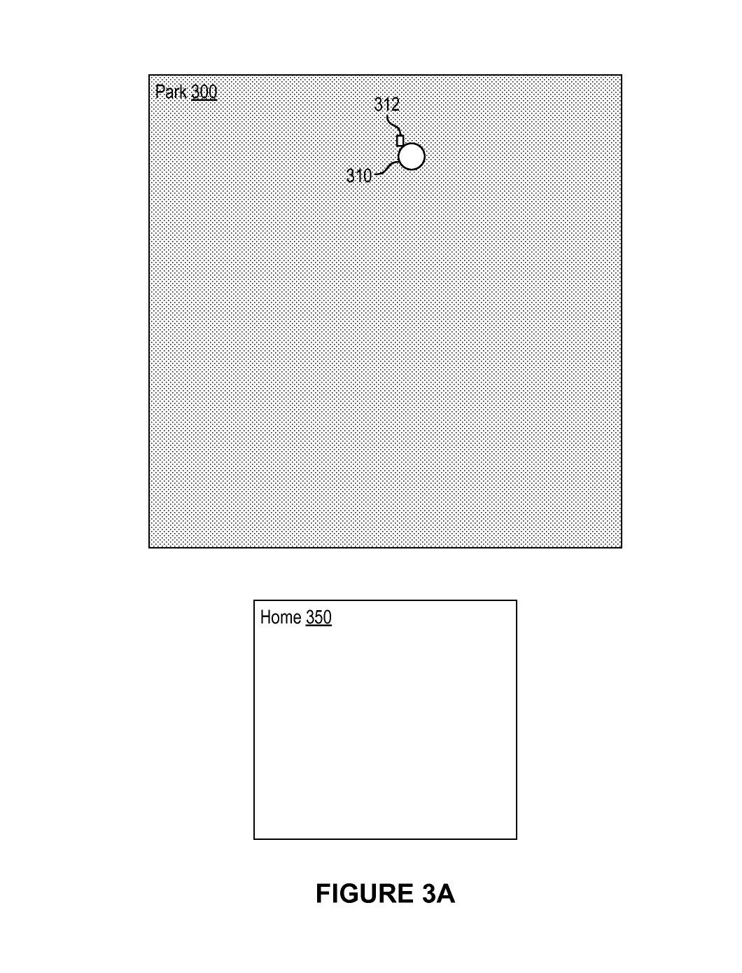

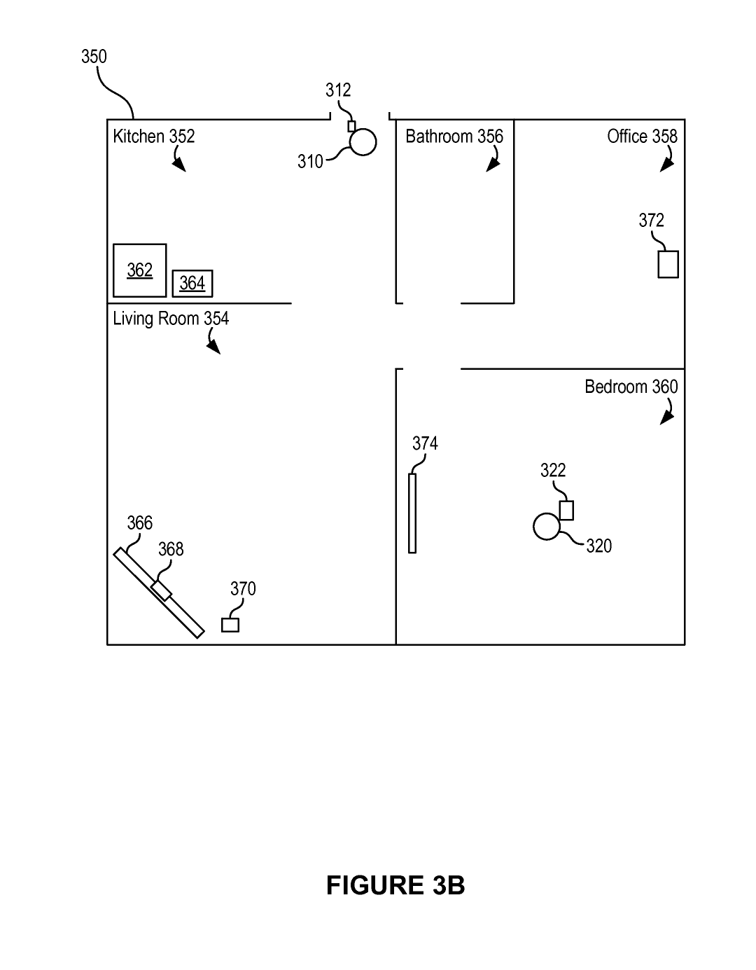

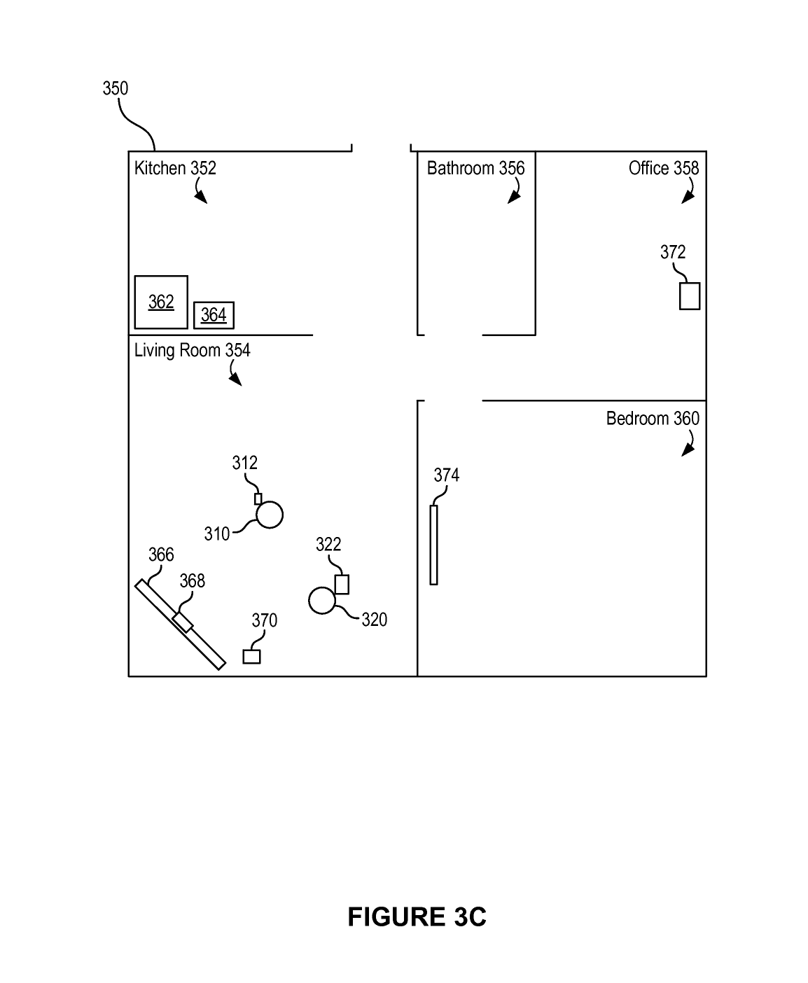

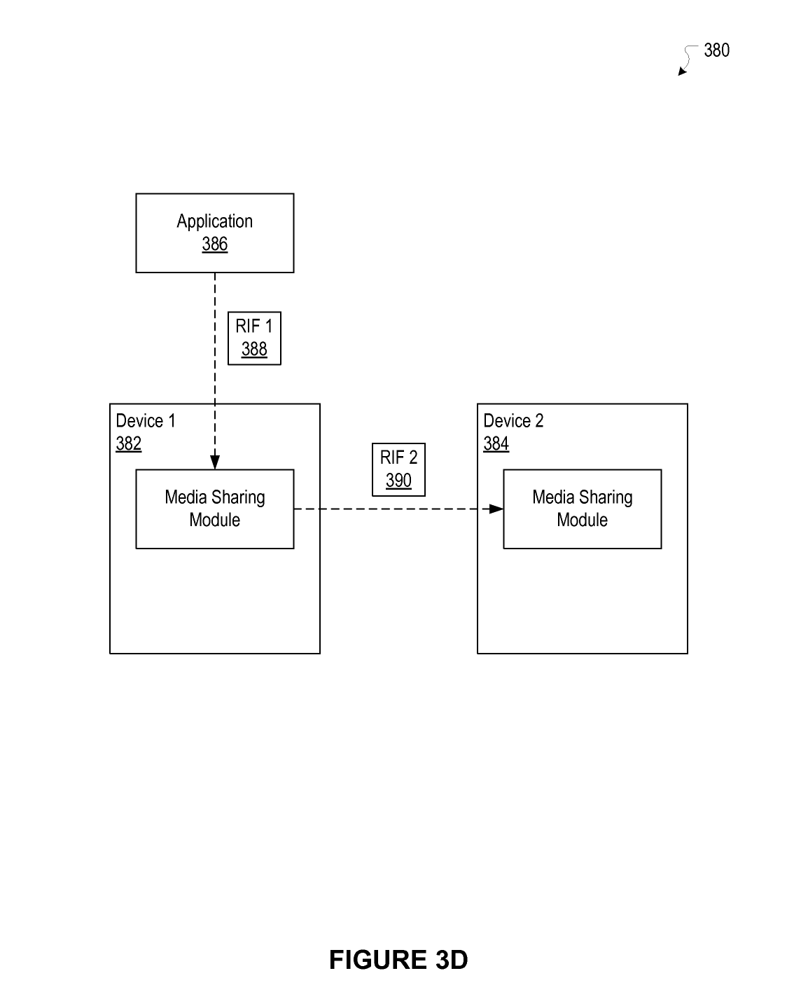

FIG. 3A illustrates an example scenario in which proactive media data sharing can be utilized, according to an embodiment of the present disclosure. In the example scenario, there can be a park 300, a user 310 in the park 300, and a home 350 near the park 300. The home 350 near the park 300 can, for example, correspond to the user's home. Furthermore, the user 310 can possess a computing device 312 (e.g., 500 in FIG. 5). In some cases, the computing device 312 can be running a media sharing module (e.g., 102 in FIG. 1).

In this example scenario, the user 310 can utilize the computing device 312 (or an application(s) running on the computing device 312) to input the user's intent. For example, the user 310 can intend for any pictures that the user takes at the park to be displayed on his or her living room television for the user 310 and the user's spouse to see. The computing device 312 (or the application(s) running on the device 312) can generate at least one actionable rule based on the user's intent. The computing device 312 can generate the at least one actionable rule to include a set of conditions and a set of actions. Moreover, the device 312 can generate an RIF document to incorporate the at least one actionable rule including the set of conditions and the set of actions.

In this example, the set of conditions can include: 1) the user's computing device 312 had taken one or more pictures; 2) the one or more pictures were taken at the park 300; 3) the user's computing device 312 is now network-reachable by the living room television and vice versa (such that the pictures can be shared or transferred from the computing device 312 to the living room television); and so forth. Moreover, in this example, the set of actions can include: 1) initiating a sharing or transferring of the pictures (when the device 312 and living room television are network-reachable with respect to one another).

In some cases, there can be an additional fourth condition: 4) the user 310 and the user's spouse are near the living room television (such that the device 312 can message the user 310 asking if the user 310 would like to display the pictures on the living room television). It follows that there can be an additional action: 2) message the user 310 asking if he or she would like to display the pictures on the living room television (when the user 310 and the user's spouse are near the living room television and when at least a portion of the pictures has been shared with the living room television and is ready to be displayed on the living room television). In some embodiments, the fourth condition can be included in a set of conditions separate from the set that includes the first, second, and third conditions. Similarly, the second action can be in a set of actions that is separate from the set that includes the first action. It is contemplated that there can also be various other conditions and/or actions.

In the example scenario of FIG. 3A, the user 310 can use the computing device 312 to take some pictures at the park 300 and can begin to return home 350. As such, the media sharing module on the device 312 can determine that the first condition is satisfied because the user 310 took some pictures using the device 312. Also, the second condition can be satisfied because the pictures can have location-related tags or information indicating that they were taken at the park 300 (e.g., GPS coordinates that are associated with the park 300, a street address that is associated with the park 300, etc.).

FIG. 3B illustrates the example scenario of FIG. 3A in which proactive media data sharing can be utilized, according to an embodiment of the present disclosure. In FIG. 3B, the user 310 had taken some pictures at the park using the computing device 312 and has now returned home 350. The home 350 can include a kitchen 352, a living room 354, a bathroom 356, an office 358, and a bedroom 360. There can also be a wide variety of computing devices (and/or systems) in the user's home 350. In the example of FIG. 3B, there can be computing devices such as a smart refrigerator 362, a smart oven 364, a smart television 366 in the living room 354 (i.e., living room television), a gaming console 368, a communications device 370 (e.g., wireless router), a desktop computer 372, and another smart television 374 (i.e., bedroom television). The user's spouse 320 can also be at home 350. Moreover, the user's spouse 320 can possess and/or use a tablet computer 322.

In this example scenario, when the user 310 returns home 350, his or her computing device 312 can be configured to automatically connect to one or more networks present at home 350. The device 312 can, for example, establish a connection (e.g., WiFi connection) with the communications device 370 (e.g., WiFi router). The other devices (e.g., 322, 362, 364, 366, 368, 372, 374, etc.) can be connected to the communications device 370 as well. Moreover, the computing device 312 can connect to at least some of the other devices via other networks (e.g., WiMAX, Bluetooth®, infrared (IR), cellular network, etc.). As such, the user's computing device 312 is network-reachable by the other devices in the home 350 and vice versa. Therefore, the media sharing module on the device 312 can determine that the third condition is satisfied as well (in addition to the first and second conditions being satisfied). As such, the first action to share or transfer the pictures from the device 312 to the living room television 366 can be initiated. In some embodiments, each of the devices at home (including the living room television 366) can be running an instance of the media sharing module. As such, an action manager and/or a cache manager of the media sharing module on the device 312 can communicate with an action manager and/or a cache manager of the media sharing module on the living room television 366 to facilitate the sharing or transferring of the pictures.

FIG. 3C illustrates the example scenario of FIG. 3B in which proactive media data sharing can be utilized, according to an embodiment of the present disclosure. Continuing with the example scenario above, at least a portion of the pictures from the user's device 312 can be shared with the living room television 366 and can be ready to be displayed on the living room television 366. Moreover, as shown in FIG. 3C, the user 310 and the user's spouse 320 can be in front of the living room television 366.

In some implementations, context data indicating the locations of the user 310 and the spouse 320 can be acquired or determined based on the locations of their respective devices (e.g., 312 and 322, respectively). For example, computing devices (e.g., 312 and 322) can determine their respective locations based on GPS, wireless signal strength, cellular triangulation, and/or various other technologies. In this example, the devices' locations can be provided as context data, which can be further used to infer additional context data about the locations of the user 310 and spouse 320.

In some embodiments, the locations of the user's and spouse's devices (e.g., 312 and 322) can be determined with the help of other devices (e.g., 362, 364, 366, 368, 370, 372, 374, etc.). For example, if the user's device 312 and the spouse's device 322 each have a strong Bluetooth® or IR connection with the living room television 366, then there can be context data that specifies that the devices (312 and 322) are near the living room television 366.

Additionally or alternatively, at least some computing devices can have sensors, such as proximity sensors, image sensors (e.g., cameras), audio sensors (e.g., microphones), etc., which can be configured to facilitate determining the locations (and/or identifies) of the user 310 and the spouse 320. In the example scenario, the living room television 366 and/or the gaming console 368 can comprise cameras and/or microphones which can be used to detect or verify that the user 310 and the spouse 320 are in front of the television 366.

Since the user 310 and the spouse 320 are near (e.g., in front of) the living room television 366, the media sharing module on the user's 312 can determine that the fourth condition (that the user 310 and the spouse 320 are near the television 366) is also satisfied. The user's 312 can thus perform the second action and message the user 310 about displaying the pictures on the television 366. If the user 310 grants permission (e.g., responds affirmatively), the pictures can be displayed on the living room television 366.

It is contemplated that many other examples, applications, and/or variations are also possible. For example, various embodiments of the present disclosure can be used to manage notifications in computing devices. In another example, a fitness app can be automatically launched when a user is exercising. In another example, music that is currently playing on a computing device can automatically be played on a network speaker. In a further example, HTML5-based documents can be proactively transferred to a television for later viewing. In a further example, various embodiments can be utilized to provide video birthday gifts. In another example, an app can be substantially simultaneously launched at multiple computing devices depending on geographical context data and activities. In another example, a game app that is started and paused in a smartphone can be resumed at a tablet computer. In another example, a user can transfer a paused game from one computing device to another by simply touching or bumping one device with the other device. Furthermore, in another example, book reading temporarily paused on a tablet computer can be continued subsequently on a TV.

Moreover, in another example, music playlists and metadata about list conditions and/or state information can be transferred from a mobile device to a system in a vehicle (e.g., car, train, bus, aircraft, ship, etc.) based on proximity and/or activity. In another example, maps created on a tablet computer can be transferred to an in-vehicle computing device based on proximity and/or activity. In another example, a second-screen app in a tablet computer that matches a TV program and its events can be initiated. In another example, if the user is alone in a vehicle and receives a message on his or her computing device, then the message (or a transcription thereof) can be played via a system of the vehicle. In a further example, a slideshow can be shared with multiple users (shared decisions and multi-user conditions). In a further example, there can be a shared slideshow for multiple users such that content can be added when additional users join. In a further example, there can be proactive content caching in a separate device (e.g., digital video recorder (DVR)) for viewing on a TV. In a further example, preferences associated with a restaurant, café, or shop can be submitted automatically.

In addition, in one example, there can be proactive transferring of passengers' contents to an on-board vehicle entertainment system based on seat assignments (e.g., on a flight, train, bus, ship, etc.). In another example, there can be a TV that allows device control, and TV controls can be triggered based on device proximity with the TV. In another example, notifications from smartphones can be displayed in target devices near users. In another example, a most recent version of a document can be transferred to a TV for viewing. In a further example, a document can be collected proactively and displayed based on a time parameter. In a further example, a user can ride a bike and a wearable computing device (e.g., smart watch) can show the road map periodically. In another example, a user can ride a bike and a wearable computing device (e.g., smart watch) can show the road map based on the user's gesture(s). Again, it is contemplated that numerous other examples, applications, and/or variations are also possible.

FIG. 3D illustrates an example system 380 in which proactive media data sharing can be utilized, according to an embodiment of the present disclosure. The example system 380 can include a first device 382, a second device 384, and one or more applications (or other components) 386.

In the example of FIG. 3D, the one or more applications (or other components) 386 can add rules (e.g., actions and conditions) that enable proactive media sharing. An Application Manager in a Media Sharing Module of the first device 382 can receive these rules, such as by receiving an RIF document that includes the rules. The Application Manager of the first device 382 can parse the RIF document, extract the data, and store the rules in a database, as previously discussed.

Continuing with the above example, in some embodiments, based on the information that it receives, the Application Manager can send the same RIF document, or a different RIF document, to one or more nearby devices based on the same premises that trigger media-sharing tasks (e.g., actions, conditions, and context, etc.).

As shown in the example of FIG. 3D, a first device (e.g., Device 1) 382 can receive a first RIF document (e.g., RIF 1) 388 from the one or more applications (or other components) 386. The first device 382 can parse and/or process rules included in the first RIF document 388.

In some cases, rules and/or context in the first device 382 can trigger the distribution of the same or a different RIF to other connected devices. As such, in some instances, multiple devices can process rules towards satisfying a single task. In the example of FIG. 3D, a rule in the first RIF document 388 can cause the first device 382 to send the same first RIF document 388 or a different RIF document to the second device 384. As shown in FIG. 3D, the first device 382 can, for example, send a second RIF document (e.g., RIF 2) 390 to the second device 384.

In some instances, the ability to distribute RIF documents can be necessary in order to implement a proactive task that may require multiple devices processing rules separately in order to proactively enable the task. One example scenario involves a “video birthday gift.”

In the “video birthday gift” example scenario, a first user can use his/her smartphone (e.g., the first device 382) to prepare a surprise birthday video for a second user. The first user's intention can be for the second user to watch the video on a living-room television (e.g., the second device 384) on the second user's birthday. The first user may or may not be near the second user when the second user is ready to watch the video on the second user's birthday. The first user's smartphone (e.g., the first device 382) can utilize a first RIF document (e.g., RIF 1 document 388) which describes a set of rules that enables proactive tasks. One of the rules in the first RIF document can specify that if the first user's smartphone is near the living-room television, then the birthday video and a second RIF document (e.g., RIF 2 document 390) are to be transferred to the living-room television. Accordingly, as soon as the first user approaches and is near the living-room television, the first user's smartphone can begin transferring the video and the second RIF document to the living-room television. The living-room television can process the second RIF document.

In the second RIF document, there can be a rule specifying that if it is the second user's birthday and if the second user is watching the living-room television, then the living-room television is to display a notification asking the second user if he/she wants to watch the birthday video. Then on the second user's birthday, the context will match the rule conditions. The rule can be executed and the second user can watch, on the living-room television, the birthday video created by the first user.

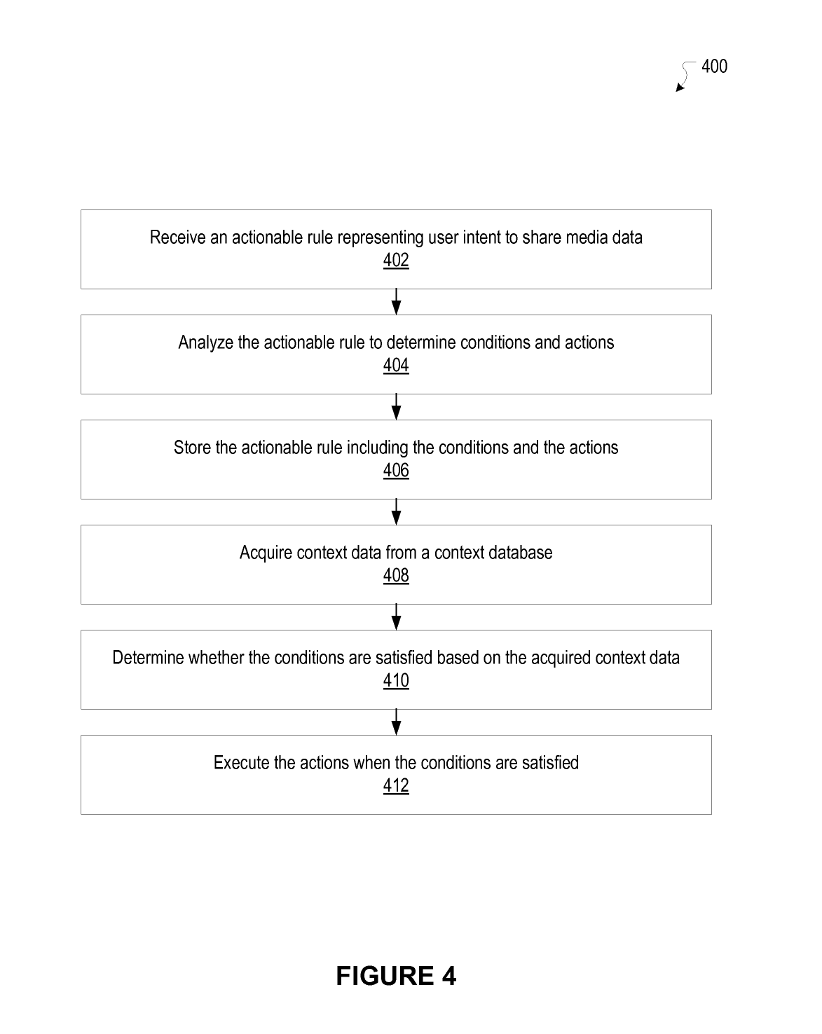

FIG. 4 illustrates an example method embodiment 400 for utilizing proactive media data sharing, according to an embodiment of the present disclosure. It should be understood that there can be additional, fewer, or alternative steps performed in similar or alternative orders, or in parallel, within the scope of the various embodiments unless otherwise stated. At step 402, the example method embodiment 400 can receive an actionable rule that represents user intent to share media data. In some embodiments, the example method 400 can receive a RIF document which includes or incorporates the actionable rule.

At step 404, the example method 400 can analyze the actionable rule to determine a set of (one or more) conditions and a set of (one or more) actions included in the actionable rule. The set of conditions can, for example, correspond to a set of (one or more) requirements (e.g., technical requirements) that need to be satisfied before the set of actions can be performed. The set of actions can, for example, correspond to a set of (one or more) tasks that need to be carried out in order to realize the user's intent to share media data.

The method 400 can store the actionable rule, including the set of conditions and the set of actions, in a rule database, at step 406. At step 408, the method 400 can acquire context data from a context database. Based on the acquired context data, the method 400 can determine whether the set of conditions is satisfied, at step 410. Step 412 can include executing the set of actions when the set of conditions is satisfied based on the acquired context data. In some embodiments, executing the set of actions can include, at least in part, initiating a sharing of the media data with at least one target system. In some cases, a target system can include a computing device (and/or system) with which the media data is to be shared, in accordance with the user's intent.

It is further contemplated that there can be many other possible uses, applications, and/or variations associated with the various embodiments of the present disclosure. In one example, data other than media data can be shared proactively using various embodiments consistent with the present disclosure. In another example, rules (e.g., actions, conditions, etc.) can be distributed among multiple devices for distributed execution. In a further example, formats other than RIF can be utilized to convey the same or a similar type of information as conveyed by RIF.

### Hardware Implementation

The foregoing processes and features can be implemented by a wide variety of machine and computer system architectures and in a wide variety of network and computing environments. FIG. 5 illustrates an example of a computer system 500 that may be used to implement one or more of the embodiments described herein in accordance with an embodiment of the invention. The computer system 500 includes sets of instructions for causing the computer system 500 to perform the processes and features discussed herein. The computer system 500 may be connected (e.g., networked) to other machines. In a networked deployment, the computer system 500 may operate in the capacity of a server machine or a client machine in a client-server network environment, or as a peer machine in a peer-to-peer (or distributed) network environment. In an embodiment of the invention, the computer system 500 may be a component of the networking system described herein. In an embodiment of the present disclosure, the computer system 500 may be one server among many that constitutes all or part of a networking system.

The computer system 500 can include a processor 502, a cache 504, and one or more executable modules and drivers, stored on a computer-readable medium, directed to the processes and features described herein. Additionally, the computer system 500 may include a high performance input/output (I/O) bus 506 or a standard I/O bus 508. A host bridge 510 couples processor 502 to high performance I/O bus 506, whereas I/O bus bridge 512 couples the two buses 506 and 508 to each other. A system memory 514 and one or more network interfaces 516 couple to high performance I/O bus 506. The computer system 500 may further include video memory and a display device coupled to the video memory (not shown). Mass storage 518 and I/O ports 520 couple to the standard I/O bus 508. The computer system 500 may optionally include a keyboard and pointing device, a display device, or other input/output devices (not shown) coupled to the standard I/O bus 508. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 500, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 500 are described in greater detail below. In particular, the network interface 516 provides communication between the computer system 500 and any of a wide range of networks, such as an Ethernet (e.g., IEEE 802.3) network, a backplane, etc. The mass storage 518 provides permanent storage for the data and programming instructions to perform the above-described processes and features implemented by the respective computing systems identified above, whereas the system memory 514 (e.g., DRAM) provides temporary storage for the data and programming instructions when executed by the processor 502. The I/O ports 520 may be one or more serial and/or parallel communication ports that provide communication between additional peripheral devices, which may be coupled to the computer system 500.

The computer system 500 may include a variety of system architectures, and various components of the computer system 500 may be rearranged. For example, the cache 504 may be on-chip with processor 502. Alternatively, the cache 504 and the processor 502 may be packed together as a “processor module”, with processor 502 being referred to as the “processor core”. Furthermore, certain embodiments of the invention may neither require nor include all of the above components. For example, peripheral devices coupled to the standard I/O bus 508 may couple to the high performance I/O bus 506. In addition, in some embodiments, only a single bus may exist, with the components of the computer system 500 being coupled to the single bus. Furthermore, the computer system 500 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 500 that, when read and executed by one or more processors, cause the computer system 500 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 500, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 502. Initially, the series of instructions may be stored on a storage device, such as the mass storage 518. However, the series of instructions can be stored on any suitable computer readable storage medium. Furthermore, the series of instructions need not be stored locally, and could be received from a remote storage device, such as a server on a network, via the network interface 516. The instructions are copied from the storage device, such as the mass storage 518, into the system memory 514 and then accessed and executed by the processor 502. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 500 to perform any one or more of the processes and features described herein.

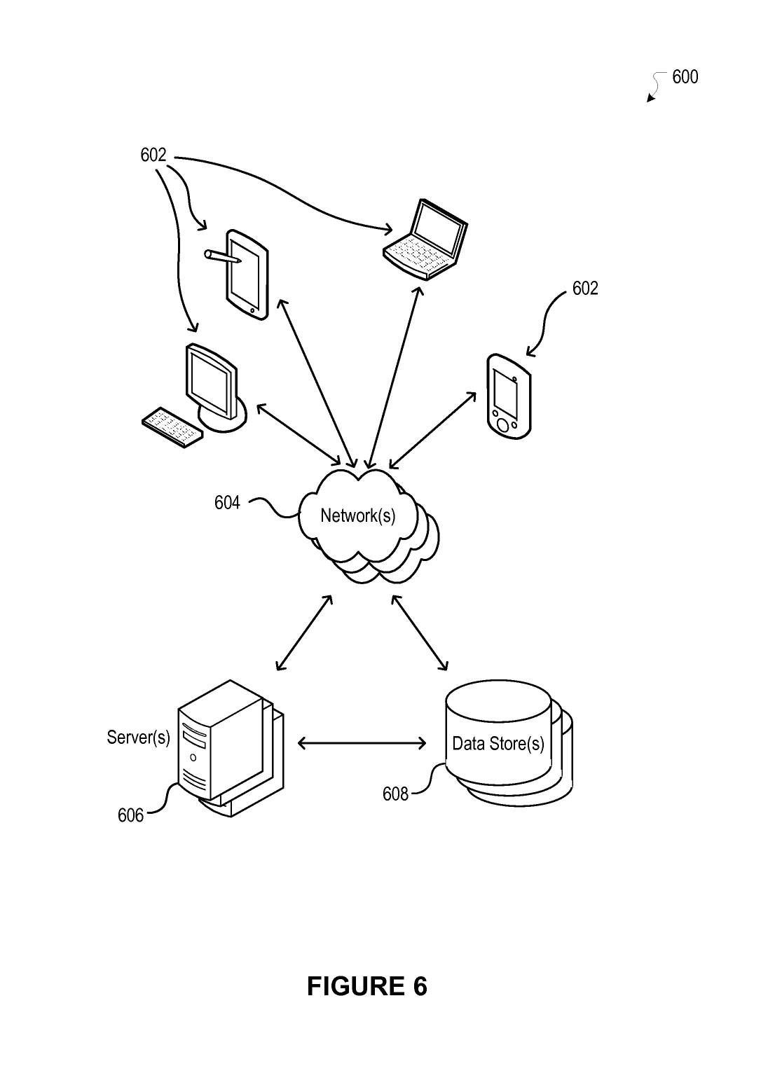

As discussed, different approaches can be implemented in various environments in accordance with the described embodiments. For example, FIG. 6 illustrates an example network system embodiment (or network environment) 600 for implementing aspects in accordance with various embodiments. The example network system 600 can include one or more computing devices, computing systems, electronic devices, client devices, etc. (e.g., 602). In some instances, each of these devices (and/or systems) 602 can correspond to the computer system 500 in FIG. 5. The example network system 600 can also include one or more networks 604. Further, there can be one or more servers 606 and one or more data stores 608 in the network system 600.

As shown in FIG. 6, the one or more example computing devices (i.e., computing systems, electronic devices, client devices, etc.) 602 can be configured to transmit and receive information to and from various components via the one or more networks 604. For example, multiple computing devices 602 can communicate with one other via a Bluetooth network (e.g., 604). In another example, multiple computing devices 602 can communicate with one other via the Internet (e.g., 604). In a further example, multiple computing devices 602 can communicate with one other via a local area network (e.g., 604).

In some embodiments, examples of computing devices 602 can include (but are not limited to) personal computers, desktop computers, laptop/notebook computers, tablet computers, electronic book readers, mobile phones, cellular phones, smart phones, handheld messaging devices, personal data assistants (PDAs), set top boxes, cable boxes, video gaming systems, smart televisions, smart appliances, smart cameras, wearable devices, sensors, etc. In some cases, a computing device 602 can include any device (and/or system) having a processor. In some cases, a computing device 602 can include any device configured to communicate via the one or more networks 604.

Moreover, regarding the computing devices 602, various hardware elements associated with the computing devices 602 can be electrically coupled via a bus. As discussed above, elements of computing devices 602 can include, for example, at least one processor (e.g., central processing unit (CPU)), at least one input device (e.g., a mouse, keyboard, button, microphone, touch sensor, controller, etc.), and at least one output device (e.g., a display screen, speaker, ear/head phone port, tactile/vibration element, printer, etc.). The computing device 602 can also include one or more storage devices. For example, the computing device 602 can include optical storage devices, disk drives, and solid-state storage devices (e.g., random access memory (“RAM”), read-only memory (“ROM”), etc.). In another example, the computing device 602 can include portable or removable media devices, flash cards, memory cards, etc.

Further, the computing device(s) 602 can include a computer-readable storage media reader, a communications device (e.g., a modem, a network card (wireless or wired), an infrared communication device, etc.). The computer-readable storage media reader can be capable of connecting with or receiving a computer-readable storage medium. The computer-readable storage medium can, in some cases, represent various storage devices and storage media for temporarily and/or more permanently storing, interacting with, and accessing data. The communications device can facilitate in transmitting and/or receiving data via the network(s) 604.

In some embodiments, the computing device 602 can utilize software modules, services, and/or other elements residing on at least one memory device of the computing device 602. In some embodiments, the computing device 602 can utilize an operating system (OS) and/or a program. For example, the computing device 602 can utilize a web browsing application to interact with and/or access various data (e.g., content) via the network(s) 604. It should be understood that numerous variations and applications are possible for the various embodiments disclosure herein.

In some embodiments, examples of the one or more networks 604 can include (but are not limited to) an intranet, a local area network (LAN, WLAN, etc.), a cellular network, the Internet, and/or any combination thereof. Components used for implementing the network system 600 can depend at least in part upon a type(s) of network(s) and/or environment(s). A person of ordinary skill in the art would recognize various protocols, mechanisms, and relevant parts for communicating via the one or more networks 604. In some instances, communication over the network(s) 604 can be achieved via wired connections, wireless connections (WiFi, WiMax, Bluetooth, radio-frequency communications, near field communications, etc.), and/or combinations thereof.

In some embodiments, the one or more networks 604 can include the Internet, and the one or more servers 606 can include one or more web servers. The one or more web servers can be configured to receive requests and provide responses, such as by providing data and/or content based on the requests. In some cases, the web server(s) can utilize various server or mid-tier applications, including HTTP servers, CGI servers, FTP servers, Java servers, data servers, and business application servers. The web server(s) can also be configured to execute programs or scripts in reply to requests from the computing devices 602. For example, the web server(s) can execute at least one web application implemented as at least one script or program. Applications can be written in various suitable programming languages, such as Java®, JavaScript, C, C# or C++, Python, Perl, TCL, etc., and/or combinations thereof.

In some embodiments, the one or more networks 604 can include a local area network, and the one or more servers 606 can include a server(s) within the local area network. In one example, a computing device 602 within the network(s) 604 can function as a server. Various other embodiments and/or applications can also be implemented.

In some embodiments, the one or more servers 604 in the example network system 600 can include one or more application servers. Furthermore, the one or more applications servers can also be associated with various layers or other elements, components, processes, which can be compatible or operable with one another.

In some embodiments, the network system 600 can also include one or more data stores 608. The one or more servers (or components within) 606 can be configured to perform tasks such as acquiring, reading, interacting with, modifying, or otherwise accessing data from the one or more data stores 608. In some cases, the one or more data stores 608 can correspond to any device/system or combination of devices/systems configured for storing, containing, holding, accessing, and/or retrieving data. Examples of the one or more data stores 608 can include (but are not limited to) any combination and number of data servers, databases, memories, data storage devices, and data storage media, in a standard, clustered, and/or distributed environment.

The one or more application servers can also utilize various types of software, hardware, and/or combinations thereof, configured to integrate or communicate with the one or more data stores 608. In some cases, the one or more application servers can be configured to execute one or more applications (or features thereof) for one or more computing devices 602. In one example, the one or more applications servers can handle the processing or accessing of data and business logic for an application(s). Access control services in cooperation with the data store(s) 608 can be provided by the one or more application servers. The one or more application servers can also be configured to generate content such as text, media, graphics, audio and/or video, which can be transmitted or provided to a user (e.g., via a computing device 602 of the user). The content can be provided to the user by the one or more servers 606 in the form of HyperText Markup Language (HTML), Extensible HyperText Markup Language (XHTML), Extensible Markup Language (XML), or various other formats and/or languages. In some cases, the application server can work in conjunction with the web server. Requests, responses, and/or content delivery to and from computing devices 602 and the application server(s) can be handled by the web server(s). It is important to note that the one or more web and/or application servers (e.g., 606) are included in FIG. 6 for illustrative purposes.

In some embodiments, the one or more data stores 608 can include, for example, data tables, memories, databases, or other data storage mechanisms and media for storing data. For example, the data store(s) 608 can include components configured to store application data, web data, user information, session information, etc. Various other data, such as page image information and access rights information, can also be stored in the one or more data stores 608. The one or more data stores 608 can be operable to receive instructions from the one or more servers 606. The data stores 608 can acquire, update, process, or otherwise handle data in response to instructions.

In some instances, the data store(s) 608 can reside at various network locations. For example, the one or more data stores 608 can reside on a storage medium that is local to and/or resident in one or more of the computing devices 602. The data store(s) 608 can also reside on a storage medium that is remote from the devices of the network(s) 604. Furthermore, in some embodiments, information can be stored in a storage-area network (“SAN”). In addition, data useful for the computing devices 602, servers 606, and/or other network components can be stored locally and/or remotely.

In one example, a user of a computing device 602 can perform a search request using the computing device 602. In this example, information can be retrieved and provided to the user (via the computing device 602) in response to the search request. The information can, for example, be provided in the form of search result listings on a web page that is rendered by a browsing application running on the computing device 602. In some cases, the one or more data stores 608 can also access information associated with the user (e.g., the identity of the user, search history of the user, etc.) and can obtain search results based on the information associated with the user.

Moreover, in some embodiments, the one or more servers 606 can each run an operating system (OS). The OS running on a respective server 606 can provide executable instructions that facilitate the function and performance of the server. Various functions, tasks, and features of the one or more servers 606 are possible and thus will not be discussed herein in detail. Similarly, various implementations for the OS running on each server are possible and therefore will not be discussed herein in detail.

In some embodiments, various aspects of the present disclosure can also be implemented as one or more services, or at least a portion thereof. Services can communicate using many types of messaging, such as HTML, XHTML, XML, Simple Object Access Protocol (SOAP), etc. Further, various embodiments can utilize network communicational protocols, such as TCP/IP, OSI, FTP, UPnP, NFS, CIFS, etc. Examples of the one or more networks 604 can further include wide-area networks, virtual private networks, extranets, public switched telephone networks, infrared networks, and/or any combinations thereof.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

It should also be appreciated that the specification and drawings are to be regarded in an illustrative sense. It can be evident that various changes, alterations, and modifications can be made thereunto without departing from the broader spirit and scope of the disclosed technology.

Moreover, the language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. A system comprising:
at least one processor; and
a memory storing instructions that, when executed by the at least one processor, cause the system to perform:
receiving an actionable rule that represents user intent to share media data;
analyzing the actionable rule to determine a set of conditions and a set of actions included in the actionable rule;
storing the actionable rule, including the set of conditions and the set of actions, in a rule database;
acquiring context data from a context database;
determining whether the set of conditions is satisfied based on the acquired context data; and
executing the set of actions when the set of conditions is satisfied based on the acquired context data, wherein executing the set of actions includes, at least in part, initiating a sharing of the media data with at least one target system.

2. The system of claim 1, wherein the instructions cause the system to further perform:
receiving new context data;
storing the new context data in the context database;
acquiring information associated with a plurality of actionable rules stored in the rule database, the information indicating sets of conditions and sets of actions included in the plurality of actionable rules;
determining that a respective set of conditions included in at least one of the plurality of actionable rules is satisfied based on the new context data; and
executing a respective set of actions included in the at least one of the plurality of actionable rules.

3. The system of claim 1, wherein the set of conditions specify at least one of a time at which the media data is to be shared, an identifier for each of the at least one target system with which the media data is to be shared, an identifier for an entity with whom the media data is to be shared, a target location for the entity, an identifier for the media data, a location at which the media data is stored, or a state of the media data.

4. The system of claim 1, wherein the instructions cause the system to further perform:
analyzing the set of conditions included in the actionable rule;
deriving one or more technical requirements based on analyzing the set of conditions, wherein determining whether the set of conditions is satisfied includes determining whether the one or more technical requirements are satisfied.

5. The system of claim 1, wherein the sharing of the media data is initiated subsequent to the at least one target system becoming network-reachable with respect to the system.

6. The system of claim 1, wherein the instructions cause the system to further perform communicating with the at least one target system to cause the media data to be provided via the at least one target system.

7. The system of claim 6, wherein the media data is provided via the at least one target system subsequent to at least a portion of the media data being shared with the at least one target system.

8. The system of claim 6, wherein the media data is provided via the at least one target system based on a state of the media data, the state of the media data indicating a paused playback position associated with the media data.

9. The system of claim 6, wherein the instructions cause the system to further perform communicating a message prior to the media data being provided via the at least one target system, the message indicating that the media data is ready to be provided via the at least one target system.

10. The system of claim 9, wherein the media data is provided via the at least one target system subsequent to receiving a command in response to the message.

11. The system of claim 1, wherein the actionable rule is represented in Rich Interchange Format (RIF).

12. The system of claim 1, wherein the context database corresponds to a deductive database, and wherein at least a portion of the context data is acquired based on inference with respect to at least two other portions of context information stored in the deductive database.

13. The system of claim 1, wherein at least a portion of the acquired context data is provided by the system.

14. The system of claim 1, wherein the media data is associated with at least one of an image, a video, an audio, a literary piece, or an application.

15. A computer-implemented method comprising:
receiving an actionable rule that represents user intent to share media data;
analyzing the actionable rule to determine a set of conditions and a set of actions included in the actionable rule;
storing the actionable rule, including the set of conditions and the set of actions, in a rule database;
acquiring context data from a context database;
determining whether the set of conditions is satisfied based on the acquired context data; and
executing the set of actions when the set of conditions is satisfied based on the acquired context data, wherein executing the set of actions includes, at least in part, initiating a sharing of the media data with at least one target system.

16. The computer-implemented method of claim 15, further comprising:
receiving new context data;
storing the new context data in the context database;
acquiring information associated with a plurality of actionable rules stored in the rule database, the information indicating sets of conditions and sets of actions included in the plurality of actionable rules;
determining that a respective set of conditions included in at least one of the plurality of actionable rules is satisfied based on the new context data; and
executing a respective set of actions included in the at least one of the plurality of actionable rules.

17. The computer-implemented method of claim 15, wherein the set of conditions specify at least one of a time at which the media data is to be shared, an identifier for each of the at least one target system with which the media data is to be shared, an identifier for an entity with whom the media data is to be shared, a target location for the entity, an identifier for the media data, a location at which the media data is stored, or a state of the media data.

18. A non-transitory computer-readable storage medium including instructions that, when executed by at least one processor of a computing system, cause the computing system to perform:
receiving an actionable rule that represents user intent to share media data;
analyzing the actionable rule to determine a set of conditions and a set of actions included in the actionable rule;
storing the actionable rule, including the set of conditions and the set of actions, in a rule database;
acquiring context data from a context database;
determining whether the set of conditions is satisfied based on the acquired context data; and
executing the set of actions when the set of conditions is satisfied based on the acquired context data, wherein executing the set of actions includes, at least in part, initiating a sharing of the media data with at least one target system.

19. The non-transitory computer-readable storage medium of claim 18, wherein the instructions cause the computing system to further perform:
receiving new context data;
storing the new context data in the context database;
acquiring information associated with a plurality of actionable rules stored in the rule database, the information indicating sets of conditions and sets of actions included in the plurality of actionable rules;
determining that a respective set of conditions included in at least one of the plurality of actionable rules is satisfied based on the new context data; and
executing a respective set of actions included in the at least one of the plurality of actionable rules.

20. The non-transitory computer-readable storage medium of claim 18, wherein the set of conditions specify at least one of a time at which the media data is to be shared, an identifier for each of the at least one target system with which the media data is to be shared, an identifier for an entity with whom the media data is to be shared, a target location for the entity, an identifier for the media data, a location at which the media data is stored, or a state of the media data.
